(19) United States
(12) Patent Application Publication
(10) Pub. No.: US 2023/0416069 A1
(43) Pub. Date: Dec. 28, 2023

(54) ASSEMBLY FOR THE BEVERAGES DISPENSING

(71) Applicant: CELLI S.P.A., SAN GIOVANNI IN (IT)

(72) Inventors: Luca CAMPANA, SAN GIOVANNI IN (IT); Andrea TONONI, SAN GIOVANNI IN (IT); Andrea Maria PALOPOLI, SAN GIOVANNI IN (IT)

(21) Appl. No.: 18/335,436

(22) Filed: Jun. 15, 2023

(30) Foreign Application Priority Data
Jun. 23, 2022 (IT) 102022000013282

(51) Int. Cl. B67D 1/00; B67D 1/12

(52) U.S. Cl. CPC B67D 1/0021; B67D 1/1234

(57) ABSTRACT

The present invention relates to an assembly for dispensing liquids, such as beverages and the like. The assembly has a connecting device, which has blocking means, and at least one hydraulic connector, in its turn connected to a respective delivery line of the machine. The assembly also includes a group of valves, for the selective mixing and/or dispensing of said liquids, which comprises a fixing member interacting with the blocking means to couple the group of valves to the connecting device. Also, the assembly provides a housing, to make a fluid-dynamic connection between the group of valves and the at least one hydraulic connector. The coupling of the blocking means and the fixing member causes the coupling of the hydraulic connector and the housing, and vice versa.

### FIELD OF INVENTION

More in detail, the invention relates to an assembly of the above type, studied and manufactured in particular to allow the connection of one or more valve groups to a beverage dispensing machine, but which can be used for any circumstance in which it is necessary to carry out a mechanical and hydraulic coupling at the same time.

In the following, the description will be directed to machines for dispensing beverages, but it is clear that the same should not be considered limited to this specific use.

### PRIOR ART

As is well known, there are currently machines for dispensing beverages. These machines include one or more valve units, each intended for dispensing a specific drink.

In particular, each group of valves comprises one or more valves, for regulating the flow of the dispensed beverage, a control unit, for regulating the valves, and connection means, for being connected to the dispensing machine.

Each group of valves is coupled to the machine via a respective connection device.

The connection devices include a member for the mechanical connection to the relative group of valves, which guarantees their mechanical coupling. Furthermore, each connection device comprises a member for the hydraulic connection, for supplying the group of valves with the beverages to be dispensed. Finally, each connection device is equipped with a member for the electrical connection, to connect the control unit to the machine.

To date, the connection and disconnection of each member of the connection device to the dispensing assembly takes place in a distinct way, in a pre-established order to guarantee the correct functioning of the machine.

A first drawback of these solutions according to the prior art is the laboriousness of the connection and disconnection process of each group of valves to the dispensing machine, which requires specialized personnel.

A further drawback of the solutions according to the prior art is the high time needed to connect and disconnect each valve group to the dispensing machine.

### SCOPE OF THE INVENTION

Therefore, the object of the present invention is to provide a connecting device that is simple to install.

A further object of the present invention is to provide a connecting device whose connection and disconnection require a reduced time.

Another object of the present invention is to provide a group of valves that can be connected to this device.

### OBJECT OF THE INVENTION

It is, therefore, specific object of the present invention an assembly for dispensing liquids, such as beverages and the like, comprising: a connecting device, which can be installed on a beverage dispensing machine having a plurality of dispensing lines for a beverage, wherein said connection device comprises blocking means, and at least one hydraulic connector, which can be fluid-dynamically connected to a respective delivery line of said machine; and a group of valves, for the selective mixing and/or dispensing of said liquids, comprising a fixing member, intended to interact with said blocking means to couple said group of valves to said connection device, and at least one housing, to make a fluid-dynamic connection between said group of valves and said at least one hydraulic connector, when said at least one hydraulic connector is coupled to said hydraulic connector, wherein said assembly is characterized in that it is configured in such a way that the coupling of said blocking means and said fixing member causes the coupling of said at least one hydraulic connector and said at least one housing, and vice versa.

Always according to the invention, said connecting device may comprise a base body, which can be fixed to said beverage dispensing machine, and said base body may have at least one seat, wherein said fixing member can be inserted, when said group of valves is connected to said connection device.

Still according to the invention, said blocking means may be arranged in correspondence with each seat, and may comprise a blocking bolt arranged so as to pass from a blocking position, wherein it is engaged to said fixing member when it is inserted in said seat, to an unlocking position, wherein it is disengaged from said fixing member, and a blocking spring, interposed between said base body and said bolt, arranged so as to keep said bolt in said locking position.

Advantageously according to the invention, said blocking bolt may protrude from said base body when in said locking position, so that it can be operated by a user to switch between said locking position to said unlocking position.

Preferably according to the invention, said hydraulic connector may comprise a shutter, arranged in correspondence with said sleeve, wherein said shutter is movable, so as to pass from a closed position, when said connecting device is separated from said group of valves, to an open position, to allow the passage of fluid, when said connecting device is coupled to said group of valves.

Always according to the invention, said sleeve may have an internal abutment surface, said shutter may have a first end and a second end, is arranged in correspondence with said sleeve, so that said second end protrudes from said sleeve, when it is in the closed position, and may have a perimeter seat, wherein a gasket is arranged, which, when said shutter is in the closed position, abuts with said abutment surface.

Still according to the invention, said connection device may comprise a closing spring, arranged in such a way as to keep the shutter in the closed position, when the valve group is connected disconnected to said connecting device.

Further according to the invention, said group of valves may comprise a plurality of dispensing valves, each arranged in such a way as to selectively allow dispensing of the beverage from a respective line dispensing machine of said beverage dispensing machine, and a nozzle for dispensing the beverage, fluid-dynamically connected to said one or more dispensing valves.

Always according to the invention, said connecting device may comprise a first transmission interface, such as an electrical, optical or pneumatic connector, for the transmission of signals and/or power, and said group of valves may comprise a second transmission interface, such as an electrical, optical or pneumatic connector, for the transmission of signals and/or power, arranged so that when said connecting device is coupled with said group of valves, said first transmission interface is in communication with said second transmission interface.

Further according to the invention, said assembly may comprise at least one elastic means, such as a preload spring, associated with said first transmission interface and/or said second transmission interface, so as to ensure the mutual contact and/or positioning between said first transmission interface and said second communication interface when they are in communication.

Further embodiments are described in the dependent claims.

### BRIEF DESCRIPTION OF THE FIGURES

The present invention will be now described, for illustrative but not limitative purposes, according to its preferred embodiments, with particular reference to the figures of the enclosed drawings, wherein:

FIG. 1 shows an axonometric view of a dispensing assembly comprising a connection device and a group of valves, both objects of the present invention, in a first embodiment, in connection configuration;

FIG. 2 shows an isometric view of the assembly shown in FIG. 1, in disconnected configuration;

FIG. 3 shows a sectional side view of the assembly shown in FIG. 1, in connection configuration;

FIG. 4 shows a sectional side view of the assembly shown in FIG. 1, in disconnected configuration;

FIG. 5 shows a top sectional view of the assembly shown in FIG. 1, in connection configuration;

FIG. 6 shows a top sectional view of the assembly shown in FIG. 1, in disconnected configuration;

FIG. 7 shows a second side sectional view of the assembly shown in FIG. 1, in connection configuration;

FIG. 8 shows a second side sectional view of the assembly shown in FIG. 1, in disconnected configuration;

FIG. 9 shows an axonometric view of the dispensing assembly comprising a connection device and a group of valves, both objects of the present invention, in a second embodiment, in connection configuration;

FIG. 10 shows an isometric view of the assembly shown in FIG. 9, in disconnected configuration;

FIG. 11 shows a sectional side view of the assembly shown in FIG. 9, in connection configuration;

FIG. 12 shows a sectional side view of the assembly shown in FIG. 9, in disconnected configuration;

FIG. 13 shows a top sectional view of the assembly shown in FIG. 9, in connection configuration; and

FIG. 14 shows a top sectional view of the assembly shown in FIG. 9, in disconnected configuration.

### DETAILED DESCRIPTION

In the various figures, similar parts will be indicated with the same reference numbers.

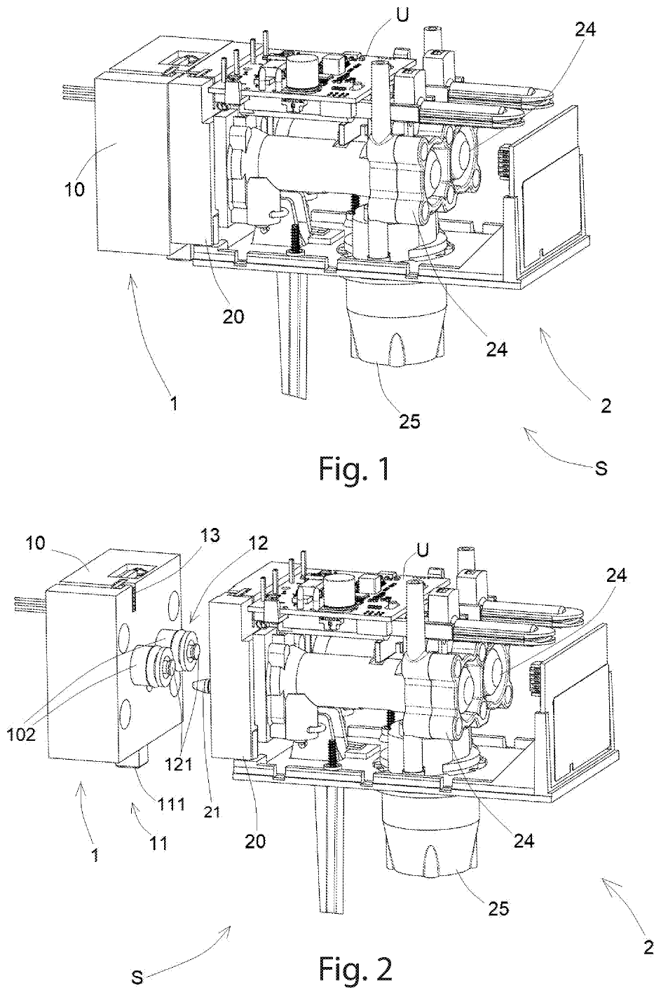

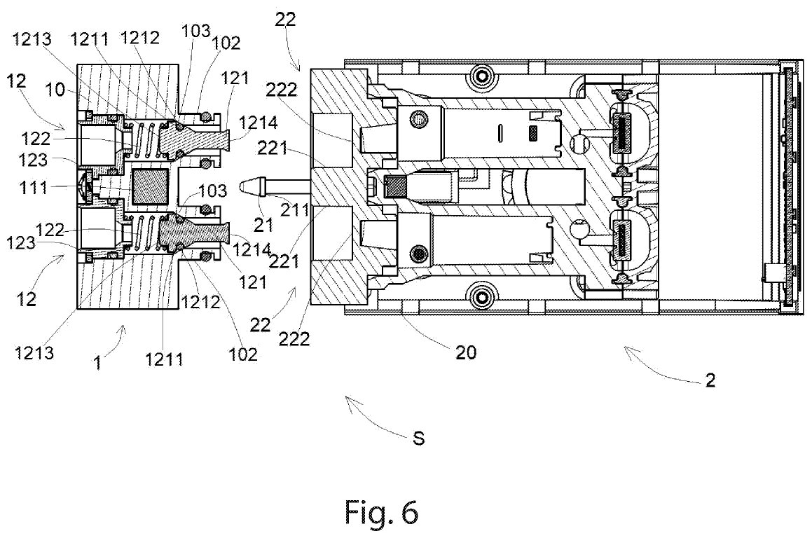

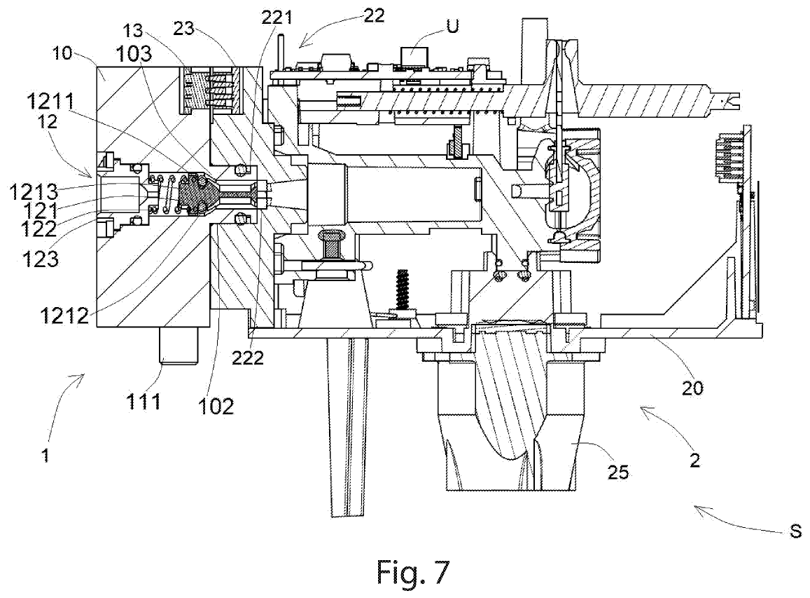

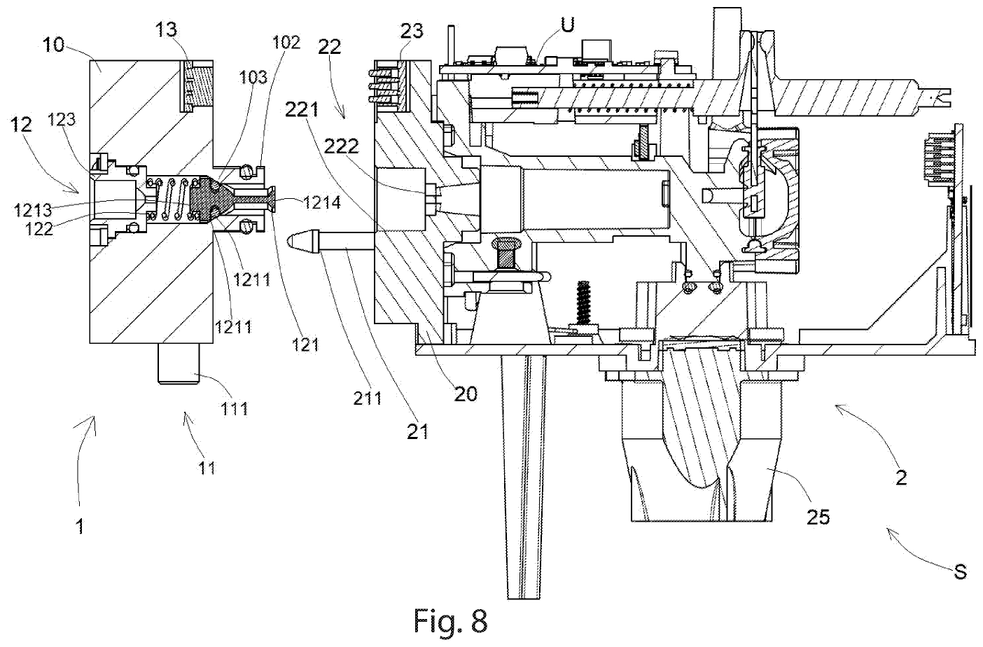

With reference to FIGS. 1-8, it is possible to observe a dispensing assembly S, object of the present invention, in a first embodiment.

The assembly S essentially comprises a connecting device 1 and a group of valves 2.

The connecting device 1 and the group of valves 2 can assume a connection configuration, in which they are mutually coupled, and a disconnection configuration, in which they are not coupled to each other.

The connecting device 1 is generally intended to be installed in a beverage dispensing machine, from which it receives one or more liquids to be mixed and/or dispensed, and then conveyed into the valve group 2, before mixing and subsequent dispensing usually through a nozzle. By way of example, the group of valves 2 can provide two channels, one for the water and one for the syrup, so that the drink obtained is a non-alcoholic drink.

The connecting device 1 comprises a base body 10, blocking means 11, one or more hydraulic connectors 12, and an electrical connector 13. In general, said electrical connector 13 is a transmission interface, for transmitting signals and/or power. For example, in other embodiments, said transmission interface can be, by way of example, of the optical or pneumatic type.

Similarly, the group of valves 2 comprises a support body 20, a fixing pin 21, shaped at the top, so as to include a blocking tooth 211, and one or more housings 22, each intended to house a respective connector hydraulic connector 12 of the connecting device 1. Furthermore, the group of valves 2 also comprises an electrical connector 23, the function of which will be better explained below. Similarly to the connecting device 1, the electrical connector 23 is a transmission interface, also in this case, for the transmission of signals and/or power, which can, in other embodiments, be, by way of example, of the optical or tire.

In other embodiments, at least one elastic means (not shown in the figure) is provided, such as a preload spring, associated with the first transmission interface 13 and/or with the second transmission interface 23. This spring ensures contact and/or mutual positioning between the first transmission interface 13 and the second communication interface 23 when they are in communication.

In other embodiments it is possible to provide other fixing members 21 instead of the described fixing pin, such as a hook, a hook member and the like.

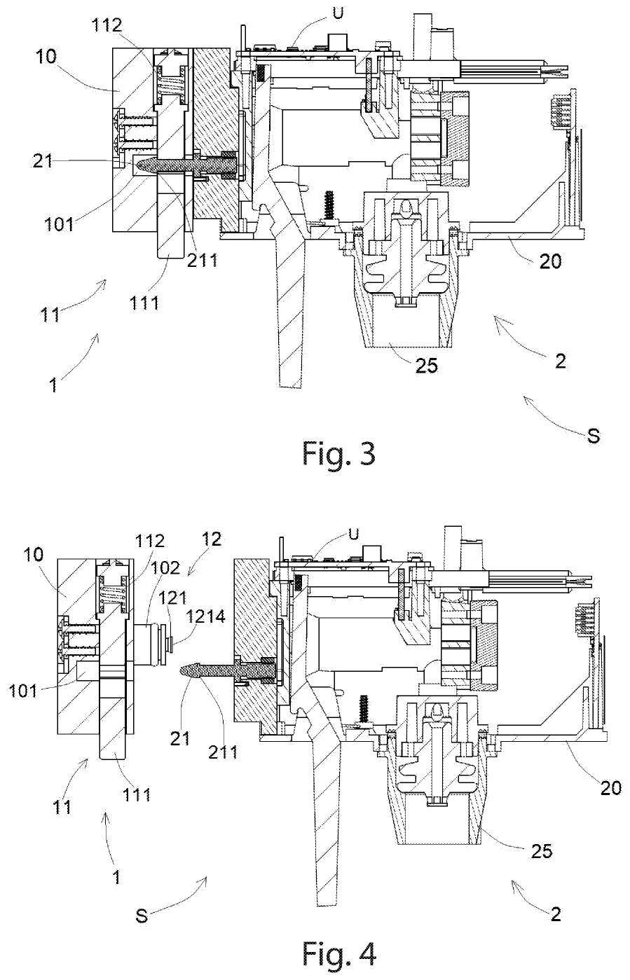

With reference to FIGS. 3-6, the base body 10 has a seat 101, in which said fixing pin 21 can be inserted, when the group of valves 2 is connected to said connecting device 1.

Furthermore, the base body 10 comprises a protruding sleeve 102, such that each dispensing line of the beverage to be dispensed coming from the connecting device 1 to the valve group 2 passes through a respective sleeve 102. When the connecting device 1 is coupled to the group of valves 2, the sleeve 102 fits into a respective housing 22, obtained on the support body 20 of the group of valves 2.

Furthermore, each sleeve 102 has an internal abutment surface 103, the operation of which will be better explained below.

The blocking means 11 of the connecting device 1 are arranged at each seat 101 and comprise a blocking bolt 111 and a blocking spring 112.

The locking latch 111 can switch from a locked to an unlocked position.

In said locking position, the blocking bolt 111 is engaged with the blocking tooth 211 of the fixing pin 21, when the latter is inserted in the respective seat 101 of the base body 10, thus ensuring stable coupling between the of valves 2 and the connecting device 1. In this configuration, the blocking bolt 111 is held in the blocked position by the blocking spring 112.

On the other hand, to pass from said blocked position to said unblocked position, the blocking bolt 111 can be operated by an operator or user, who, by moving it, overcomes the resistance of said blocking spring 112, disengaging it from said blocking tooth 211 of the fixing pin 21. In this way, the fixing pin 21 can be extracted from the seat 101 and the connecting device 1 separated from said group of valves 2.This release operation can be performed by the operator using only one hand, since the blocking bolt 111, together with the blocking spring 112, actually function as a button, so that it is possible to move, or press, the blocking bolt 111 with just one hand—or just one finger—by releasing the fixing pin 21.

In the embodiment shown in FIGS. 1-8, the fixing pin 21 of the valve group 2 has the free end substantially conical or tapered in shape. This allows the fixing pin 21 to be inserted into the seat 101 without necessarily having to manually operate the blocking bolt 111. In fact, this conical or tapered shape of the top of the fixing pin 21 progressively moves the blocking bolt 111 from the blocking position to the unblocking position during the insertion, again overcoming the opposition of the blocking spring 112, to then allow it to return to the blocking position when fully inserted in the seat 101 and engage with said blocking tooth 211. Therefore, the engagement operation between the group of valves 2 and the connecting device 1 is extremely simple as it takes place automatically by inserting the fixing pin 21 in the respective seat 101 of the base body 10.

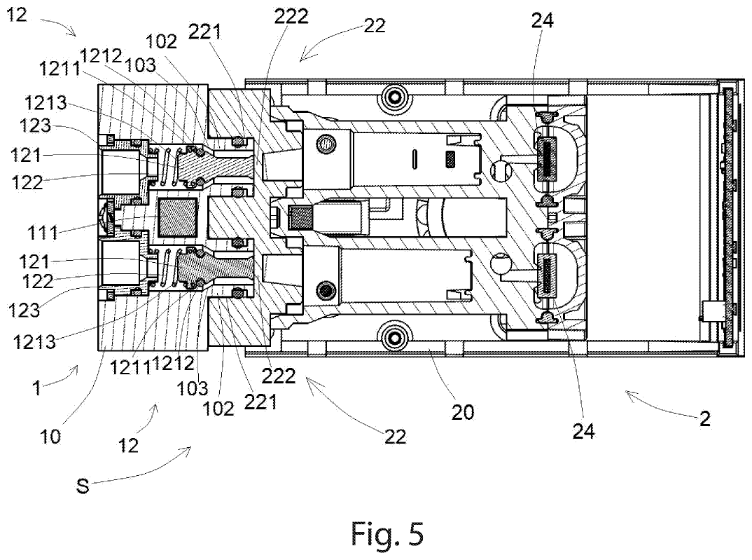

With reference to FIGS. 5-8, each hydraulic connector 12 mainly comprises a shutter 121 and a closing spring 122.

The shutter 121 has a peripheral seat 1211, in which a gasket 1212 is arranged, and a first end 1213 and a second end 1214.

Said shutter 121 is at least partially arranged inside the sleeve 102 and is movable, so as to pass from a closed position, in which said second end 1214 protrudes with respect to the sleeve 102 and prevents the passage of liquid through the sleeve 102 itself, in which the circular gasket 1212 abuts against the abutment surface 103, having a frusto-conical shape, of the sleeve 102; to an open position, in which it allows the passage of liquid, in which the gasket 1212 is no longer in abutment with said abutment surface 103.

The closing spring 122 is interposed between said first end of the shutter 121 and a bush 123, the latter arranged in said base body 10 of said connecting device 1. Said closing spring 122 keeps the shutter 121 in the closed position, when the valve group 2 and the connecting device 1 are disconnected.

Each of said housings 22 of the group of valves 2 is a cavity delimited by a side wall 221 and a base 222. Each housing 22 can house a respective sleeve 102, to allow the fluid dynamic connection between the connecting device 1 and the group of valves 2.

The base 222 acts as a pressure element, as it makes the shutter 121 pass from said closed position to said open position, when the connecting device 1 and the group of valves 2 pass from the disconnection configuration to the connection configuration, since the second end 1214 of said shutter 121 interferes with said base 222, overcoming the resistance of the closing spring 122.

The electrical connector 13 of the connecting device 1 and the electrical connector 23 of the group of valves 2 are configured to allow the electrical connection by contact between the connecting device 1 and the group of valves 2, in connection configuration. The electrical connector 13 is connected to the control logic unit of the beverage dispensing machine, in which the assembly S is installed so that the latter can then control the opening of the valves of the valve group 2.

The group of valves 2 comprises one or more dispensing valves 24, in equal number to said hydraulic connectors 12 of the connecting device 1, at least one nozzle 25 and a control unit U. In the embodiment shown in the figure, the group of valves 2 includes two valves. In other embodiments, the number of dispensing valves 24 may be more or even less.

Each dispensing valve 24 and the control unit U are housed inside the support body 20 of the group of valves 2.

The dispensing valve 24 is connected to the control unit U and is in fluid dynamic connection with said housing 22.

The dispensing valve 24 is configured to receive the liquid coming from said seat 22 and convey it to said nozzle 25. In particular, the dispensing valve 24, suitably controlled indirectly by the logic control unit of the machine and directly by the control unit U, allows adjusting the flow rate and volume of overall and mixed liquid that is dispensed from the nozzle 25.

The control unit U is connected to the electrical connector 23.

The operation of the first embodiment of the assembly S described above is as follows.

The connecting device 1 installed on a beverage dispensing machine is considered. In general, each beverage dispensing machine can provide for the dispensing of several beverages through a respective nozzle 25. Therefore, in general, each machine will install a plurality of connecting devices 1.

When an operator intends to couple a group of valves 2 to a respective connecting device 1, i.e., make them pass from the disconnection configuration to the connection configuration, s/he brings the group of valves 2 closer to the connecting device 1, so that said fixing pin 21 fits into the respective seat 101. At the same time, each of said sleeves 102 fits into a respective seat 22 and the electric connector 13 of the connecting device 1 connects to the electric connector 23 of the group of valves 2.

The operator then operates said blocking bolt 111, to make it pass from the blocked position to the unblocked position, overcoming the resistance of the blocking spring 112.

The operator can then insert the fixing pin 21 of the valve group 2 into the seat 101 of the connecting device 1. The operator can then release the blocking bolt 111, which is pushed by the blocking spring 112 and returns to the blocking position, interfering with the blocking tooth 211, thus blocking the valve group 2 in position.

As anticipated, it is also possible that the fixing pin 21 is inserted in the seat 101 without activating the blocking bolt 111, due to its conical or tapered conformation, capable of progressively moving the blocking bolt 111 from the blocking position to the unblocking position during the insertion, and then allowing it to return to the locked position when fully inserted into the seat 101.

The insertion of the fixing pin 21 corresponds to the coupling of said hydraulic connectors 12 of the connection device with said housings 22 of said group of valves 2. In particular, each sleeve 102 fits completely into the respective housing 22.

When the sleeve 102 is fully inserted into the housing 22, the base 222 moves the shutter 121 from the closed position to the open position, allowing the passage of liquid into and through the sleeve 102.

The insertion of the fixing pin 21 also corresponds to the coupling of said electrical connector 13 of the connecting device 1 with the electrical connector 23 of the group of valves 2. In particular, when the group of valves 2 is switched to the configuration connection, the electrical connection powers the control unit U.

When the valve group 2 and the connecting device 1 are in connection configuration, it is then possible to adjust the flow rate and volume of beverages or other liquids via the dispensing valves 24 and dispense them from the nozzle 25.

If it is intended to disconnect the group of valves 2 from the connecting device 1, i.e. make them pass from the connection configuration to the disconnection configuration, the operator operates the blocking means 11.

In particular, the operator operates the blocking bolt 111, compressing the blocking spring 112 and making it pass from the blocked position to the unblocked position.

The operator then extracts the fixing pin 21 of the valve group 2 from the seat 101, moving the valve group 2 away from the connecting device 1. The operator then releases the blocking bolt 111.

The removal of the group of valves 2 from the connecting device 1 causes each sleeve 102 to come out of the respective housing 22 of the group of valves 2. Consequently, the base 222 releases the shutter 121, which is returned from the open position to the closed position by the closing spring 122.

The gasket 1212 is thus pressed onto the abutment surface 103, preventing the passage of liquid through the sleeve 102.

The removal of the group of valves 2 from the connecting device 1 also involves the disconnection of the electrical connector 23 of the group of valves 2 from the electrical connector 13 of the connecting device 1.

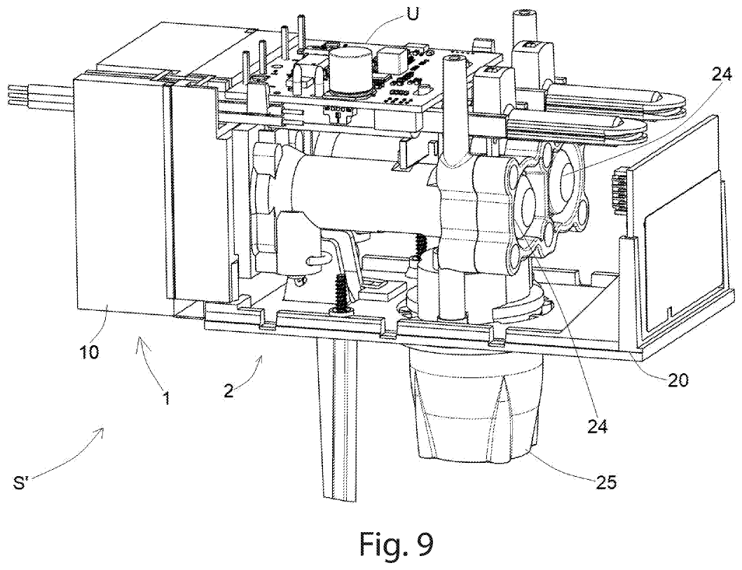

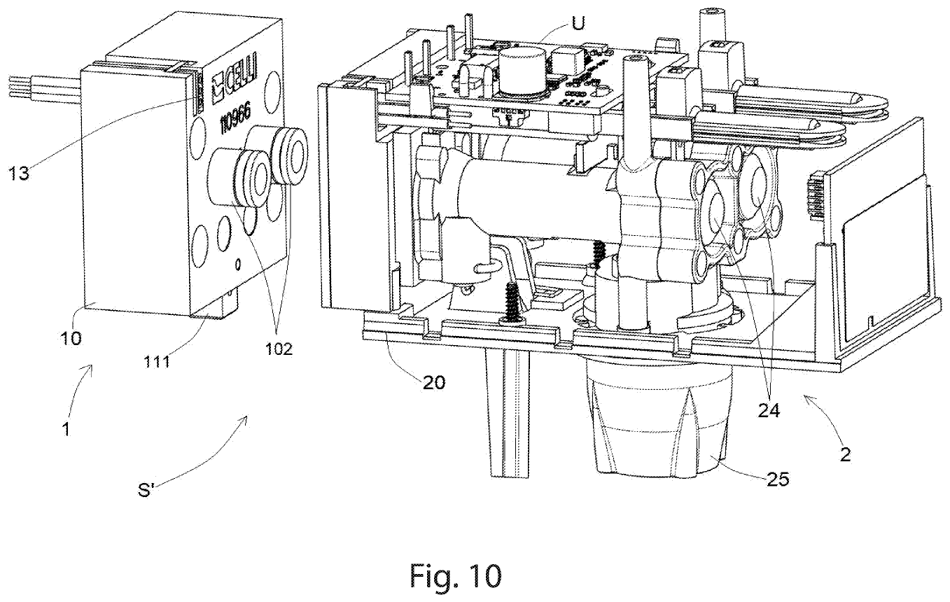

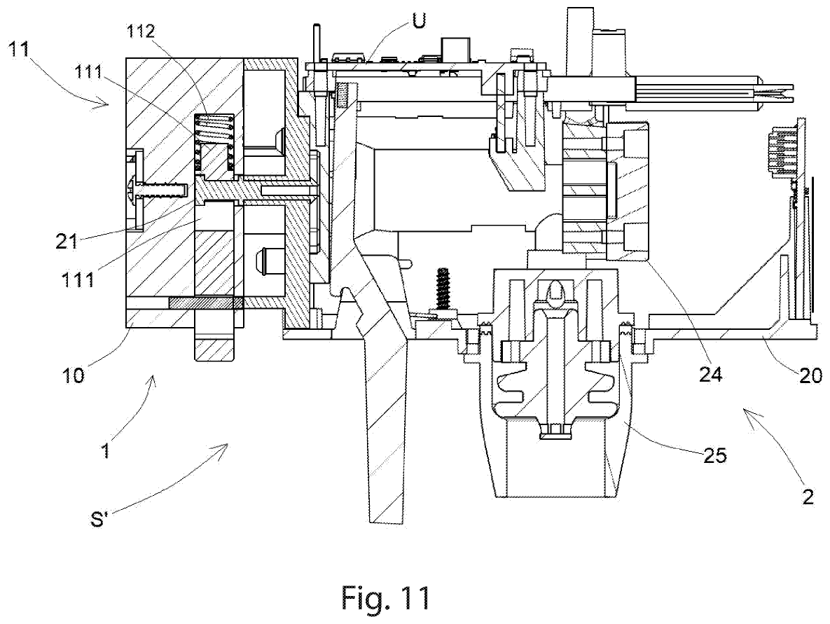

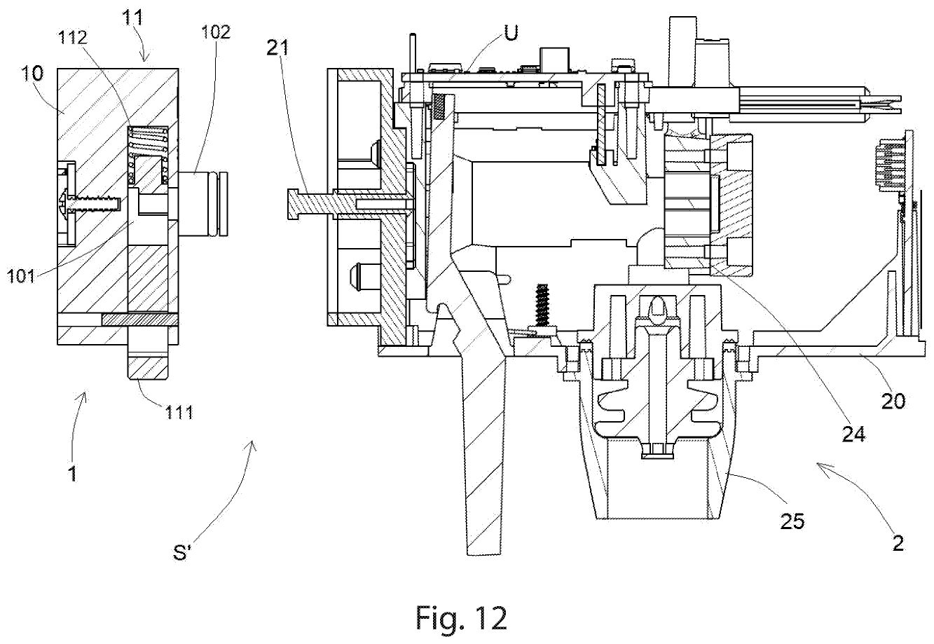

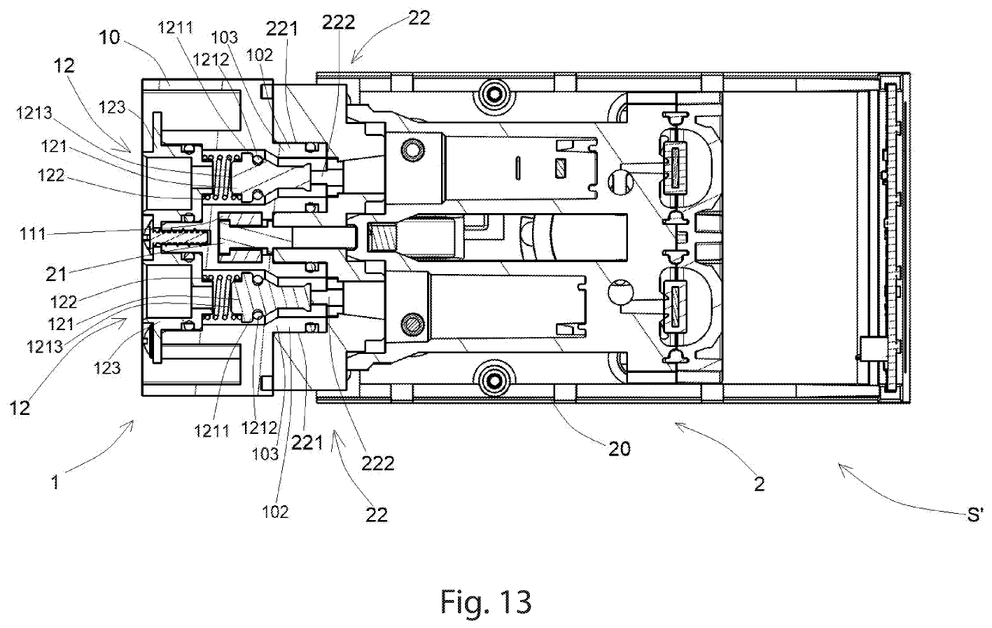

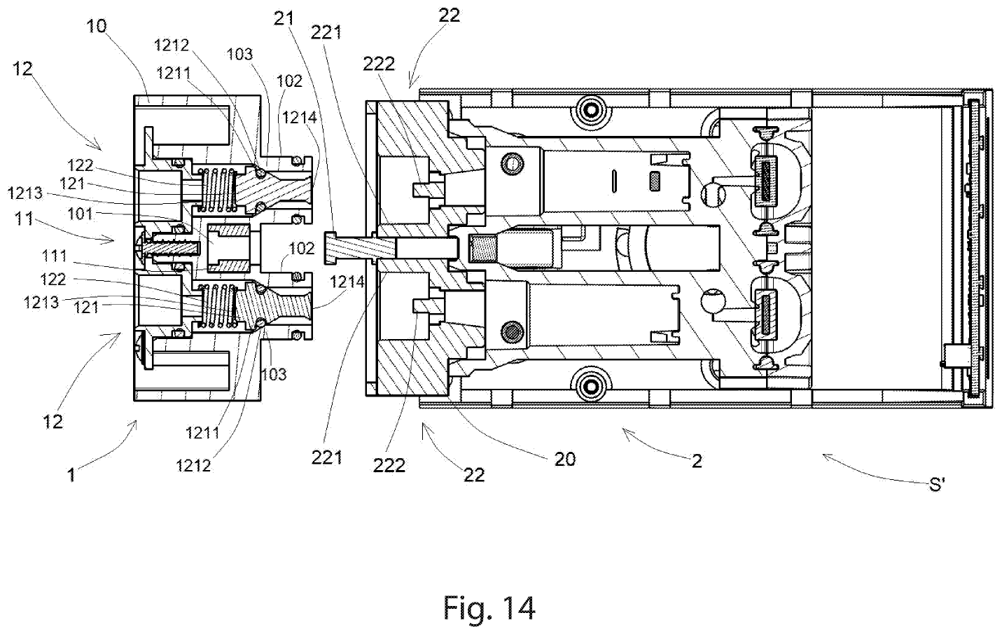

With reference now to FIGS. 9-14, it is possible to observe a second embodiment of the dispensing assembly S′, object of the present invention.

In this case, the fixing pin 21 of the valve group 2 does not have a conical or tapered shape, capable of progressively moving the blocking bolt 111 from the blocked position to the unblocked position during insertion.

The operation of the assembly S′ in the second embodiment described above is completely analogous to that described for the assembly S in said first embodiment.

### Advantages

A first advantage of the present invention is the possibility of having a connection device that is simple to use.

A further advantage of the present invention is the possibility of having a group of valves whose connection and disconnection from this connection device requires a reduced time.

The present invention has been described for illustrative but not limitative purposes, according to its preferred embodiments, but it is to be understood that modifications and/or changes can be introduced by those skilled in the art without departing from the relevant scope as defined in the enclosed claims.

1. An assembly for dispensing liquids, such as beverages and the like, comprising:
a connecting device, which can be installed on a beverage dispensing machine having a plurality of dispensing lines for a beverage, wherein said connecting device comprises
blocking means, and
at least one hydraulic connector, which can be fluid-dynamically connected to a respective delivery line of said machine; and
a group of valves, for the selective mixing and/or dispensing of said liquids, comprising
a fixing member, intended to interact with said blocking means to couple said group of valves to said connecting device, and
at least one housing, to make a fluid-dynamic connection between said group of valves and said at least one hydraulic connector, when said at least one hydraulic connector is coupled to said hydraulic connector,
wherein said assembly (S) is configured in such a way that the coupling of said blocking means and said fixing member causes the coupling of said at least one hydraulic connector and said at least one housing, and vice versa.

2. The assembly of claim 1,
wherein said connecting device comprises a base body, which can be fixed to said beverage dispensing machine, and
wherein said base body has at least one seat, wherein said fixing member can be inserted, when said group of valves is connected to said connecting device.

3. The assembly of claim 2, wherein said blocking means are arranged in correspondence with each seat, and comprise
a blocking bolt arranged so as to pass from a blocking position, wherein it is engaged to said fixing member when it is inserted in said seat, to an unlocking position, wherein it is disengaged from said fixing member, and
a blocking spring, interposed between said base body and said bolt, arranged so as to keep said bolt in said locking position.

4. The assembly of claim 3, wherein said blocking bolt protrudes from said base body when in said locking position, so that it can be operated by a user to switch between said locking position to said unlocking position.

5. The assembly of claim 1, wherein said hydraulic connector comprises a shutter, arranged in correspondence with said sleeve, wherein said shutter is movable, so as to pass from a closed position, when said connecting device is separated from said group of valves, to an open position, to allow the passage of fluid, when said connecting device is coupled to said group of valves.

6. The assembly of claim 5, characterized
in that said sleeve has an internal abutment surface,
in that said shutter
has a first end and a second end,
is arranged in correspondence with said sleeve, so that said second end protrudes from said sleeve, when it is in the closed position, and
has a perimeter seat, wherein a gasket is arranged, which, when said shutter is in the closed position, abuts with said abutment surface.

7. The assembly of claim 6, wherein said connecting device comprises a closing spring, arranged in such a way as to keep the shutter in the closed position, when the valve group is connected disconnected to said connecting device.

8. The assembly of claim 1, wherein said group of valves comprises
a plurality of dispensing valves, each arranged in such a way as to selectively allow dispensing of the beverage from a respective line dispensing machine of said beverage dispensing machine, and
a nozzle for dispensing the beverage, fluid-dynamically connected to said one or more dispensing valves.

9. The assembly of claim 1, characterized
wherein said connecting device comprises a first transmission interface, such as an electrical, optical or pneumatic connector, for the transmission of signals and/or power, and
wherein said group of valves comprises a second transmission interface, such as an electrical, optical or pneumatic connector, for the transmission of signals and/or power, arranged so that when said connecting device is coupled with said group of valves, said first transmission interface is in communication with said second transmission interface.

10. The assembly of claim 9, characterized
in that it comprises at least one elastic means, such as a preload spring, associated with said first transmission interface and/or said second transmission interface,
so as to ensure the mutual contact and/or positioning between said first transmission interface and said second communication interface when they are in communication.
